(19) United States
(12) Patent Application Publication
(10) Pub. No.: US 2016/0326002 A1
(43) Pub. Date: Nov. 10, 2016

(54) PROCESS FOR PREPARING HIGH-PURITY SEMI-METAL COMPOUNDS

(71) Applicants: Juergen Erwin LANG, Karlsruhe (DE); Hartwig RAULEDER, Rheinfelden (DE); Jens ELSNER, Hochheim am Main (DE)

(72) Inventors: Juergen Erwin LANG, Karlsruhe (DE); Hartwig RAULEDER, Rheinfelden (DE); Jens ELSNER, Hochheim am Main (DE)

(73) Assignee: EVONIK DEGUSSA GMBH, Essen (DE)

(21) Appl. No.: 15/104,759

(22) PCT Filed: Dec. 4, 2014
(86) PCT No.: PCT/EP2014/076532

§ 371 Date: Jun. 15, 2016

(30) Foreign Application Priority Data
Dec. 16, 2013 (DE) 10 2013 226 033.4

(51) Int. Cl. C01B 33/04; B01D 3/14; B01D 69/12; B01J 19/08; B01D 53/22

(52) U.S. Cl. CPC C01B 33/04; B01J 19/088; B01D 53/229; B01D 69/12; B01D 3/145; B01J 2219/0896; B01J 2219/0805

(57) ABSTRACT

The invention relates to a process for preparing dimeric and/or trimeric silanes by reaction of monosilane in noble gas in a non-thermal plasma, and also to a plant for performance of this process.

The invention relates to a process for preparing dimeric and/or trimeric silanes by reaction of monosilane with hydrogen in a plasma and to a plant for performance of this process.

Semi-metals, for example silicon, germanium, and also boron and semi-metal compounds, such as iron silicide, gallium arsenide, gallium indium arsenic, and Ga—In—As—Sb, for example, play an important part particularly in the fabrication of semiconductors, thermoelectric, magnetocaloric generators, or solar cells.

It is therefore very important to provide access to these metals in large quantities and in the purity required for the stated applications. An example of a precursor is disilane, abbreviated “DS”. DS may be prepared thermally, photolytically or via various plasma processes, such as corona discharge or glow discharge procedures, for example. The conventional preparation of DS takes place preferably in a hydrogen matrix under overall pressures of more than 1 bar, as taught for example by WO 2006/107880 A2. In that publication, the applicant presents a thermal process for the preparation of higher silanes, which converts monosilane to disilane and/or disilane to trisilane. In the course of the process, the temperature of the reactant stream, which comprises the lower silane, is increased in two stages in a defined way, this way involving the physical dimensions of heated reactor vessels through which the stream of material passes for different durations. The partial pressure of the monosilane reactant in this case is only 1 to 60% of the total pressure. The conversion of reactant to product achieves only 1 to 10%. The product is present only at a low concentration in each case. Moreover, in the course of the gas phase treatment, there is co-formation of molecular hydrogen. Accordingly, during the final work-up of product, a relatively small fraction of higher silane, for example DS, has to be removed from a mixture with a very high fraction of hydrogen and a low silane fraction, e.g. monosilane. This circumstance makes the process very uneconomical.

Patent application DE 102013207442.5 presents a process which subjects a reactant stream comprising monosilane and hydrogen to a gas-phase treatment in a non-thermal plasma, to form disilane and/or trisilane. In the non-thermal plasma it is observed that not the entire mass of monosilane is converted. In the very process of DE 102013207442.5, therefore, provision is made to separate unreacted monosilane from the resulting phase and recycle it to the reactant stream, to bring about further conversion in the plasma. It is found, however, that only a small percentage of the unreacted monosilane is recovered from the resulting phase. Based on the amount of monosilane in the reactant stream, the process can be used to recover only small fractions from the resulting phase, generally about 7% of the monosilane used in the reactant stream.

It was an object of the present invention, therefore, to provide a process which permits simple and at the same time cost-effective processing and recovery of semi-metal precursors, suitable for realizing semiconductor functionalities, for example transistor layers, particles, alloys or nano-dot materials.

This object is achieved by the process of the invention and also by the plant of the invention in accordance with the features of Claims 1 and 10.

It has been found that in a reactant stream comprising monosilane, at a given partial pressure of the monosilane in the gas mixture, disilane and/or trisilane are formed selectively in the presence of at least one noble gas in a non-thermal plasma. Entirely unexpectedly here it has been found that a substantially higher fraction of the monosilane not converted in the non-thermal plasma is recovered than in the process presented in patent application DE 102013207442.5.

Subject matter of the invention is therefore a process for preparing dimeric and/or trimeric silanes of the general formula I

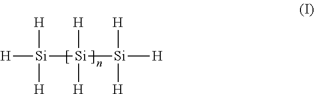

where n=0, n=1, or n=0 to 1, by
i) in a reactant stream comprising monosilane of the general formula II

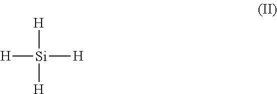

and a noble gas
ii) operating a gas discharge to give a resulting phase which comprises hydrogen, noble gas, and dimeric and/or trimeric silanes, and subsequently
iii) removing the noble gas, hydrogen, and the dimeric and/or trimeric silanes from the resulting phase.

In step i), monosilane is used preferably in the “electronic grade” quality, abbreviated “EG”, that is relevant for semiconductor electronics applications.

Used preferably as noble gas is xenon or krypton, more preferably xenon, very preferably xenon of EG quality.

In an alternative version of the process of the invention, hydrogen may be used in place of the noble gas. If molecular hydrogen is used, its behaviour in the gas discharge is comparable to that of a noble gas. Molecular hydrogen therefore constitutes an equivalent to noble gas in the sense of the invention, by virtue of its comparable behaviour in the gas discharge.

During and/or after step iii) of the process, it is possible with preference for monosilane to be recovered and to be returned to the reactant stream, in order to be processed again as per process steps i)-iii). The surprising advantage of the process is that a substantially higher fraction of the monosilane not converted in the non-thermal plasma is recovered than in the process presented in patent application DE 102013207442.5.

Preferably 5 to 10 times, more preferably at least 10 times, very preferably under a pressure of 1 bar_{abs} and at a condenser temperature of minus 120° C., about 85% of the monosilane used is recovered, together with disilane, noble gas, preferably xenon, and other fractions. One advantage is that the renewed processing purifies the noble gas, synonymous with the noble gas being freed from, or at least depleted in, impurities in the form of hydrocarbons, water, oxygen, particles and high boilers.

The process of the invention can be carried out continuously or discontinuously.

If xenon is used, in the case of the continuous implementation of the process, it should be ensured that the process gas is condensed at a temperature above the sublimation temperature of xenon, of about −130° C. In the case of a discontinuous process regime, the xenon may also be frozen out as solid for removal. Freezing may also be suitable for the purpose of recovering it from a waste gas stream.

The non-thermal plasma is generated in a plasma reactor, preferably in a corona discharge or glow discharge reactor, more preferably in a thermal or photochemical reactor. A function common to all of these reactors is that the non-thermal plasma in accordance with the claimed process brings about at least partial di- and/or trimerization of the monosilane.

Preference is given to using a “dielectric barrier discharge reactor”, in which dielectrically hindered gas discharges are generated. The non-thermal plasmas for the purposes of the invention are anisothermic. Characteristic of this is a high electron temperature Tₑ>10⁴ K, and a gas temperature T_{G} which is lower by from one to three orders of magnitude. The activation energy needed for the chemical processes is exerted predominantly through electron impacts. Typical non-thermal plasmas can be generated, for example, by glow discharge, HF discharge, hollow cathode discharge or corona discharge. The operating pressure at which the non-thermal plasma is maintained is preferably between 0.1 to 2000 mbar_{abs}, with the phase to be treated being set preferably to a temperature of −80° C. to 50° C. For a definition of non-thermal plasmas and of homogeneous plasma catalysis, reference is made to the relevant technical literature, as for example to “Plasmatechnik: Grundlagen and Anwendungen—Eine Einführung” [Plasma technology: Fundamentals and Applications—An Introduction]; collective of authors, Carl Hanser Verlag, Munich/Vienna; 1984, ISBN 3-446-13627-4.

It may be advantageous to carry out the gas discharge in process step ii) in a loop reactor and to set the pressure from 50 to 300 mbar_{abs}, and/or to set the pressure in process step iii) to 0.5 to 100 mbar_{abs}, preferably 5 mbar_{abs}. With further advantage, the gas discharge may take place at a temperature between −260° C. and 200° C. in process step ii).

It has been found that with a given reactant stream with a ratio of noble gas to monosilane, expressed in volume percent (vol %), of preferably 20:1 to 1:5, more preferably between 10:1 to 5:1, very preferably between 10:1 to 8:1, with further preference at about 90 vol % noble gas and 10 vol % monosilane, good yields of disilane and trisilane are obtained if the pressure in the gas discharge reactor is in the range from 10 to 300 mbar_{abs}. For instance, for a reactant stream of 90 vol % noble gas and 10 vol % monosilane in the non-thermal plasma, at a pressure of 10 mbar_{abs}, 0.7 g/h disilane were obtained in continuous operation, and at 20 mbar_{abs} 0.75 g/h and at 25 mbar_{abs} 0.72 g/h. A very high yield of 0.85 g/h disilane can be isolated at 50 mbar_{abs}. If the pressure is increased further, the yield can be further boosted.

The fraction of trimeric silanes of the general formula I obtained in accordance with the invention can be increased relative to the fraction of dimeric silanes obtained in accordance with the invention by implementing a further gas discharge in the resulting phase at least once, preferably precisely once, before step iii) and after step ii). In this case, a further resulting phase is obtained, in which the fraction of trimeric silanes is greater than the fraction of dimeric silanes.

It may be advantageous to remove hydrogen from the resulting phase or from the further resulting phase before implementing at least one, or one further, gas discharge.

Preferably, also, one further, or any further, gas discharge may be carried out in a loop reactor. For every further gas discharge it is possible to use one further loop reactor in each case. With particular preference, subsequent to step ii), a further gas discharge is carried out in a second loop reactor. It is further preferred, in precisely this further, or every further, gas discharge, to select the pressure from the same range as in process step ii).

If at least or precisely one further gas discharge is carried out, the temperature may be selected from the same range as in process step ii).

Particularly pure dimeric and/or trimeric silanes are obtained in the process of the invention if the reactant stream is subjected in step ii) to a pulsed non-thermal plasma. A plasma of this kind is characterized in that a non-thermal plasma is activated by means of an AC voltage of frequency f, and at least one electromagnetic pulse with repetition rate g injected into the plasma has a voltage component having an edge slope in the rising edge of 10 V ns⁻¹ to 1 kV ns⁻¹, and a pulsewidth b of 500 ns to 100 μs. High-voltage pulses with such high edge slopes permit simultaneous development of the discharge throughout the discharge space of the reactor.

Paschen's law states that the breakdown voltage for the plasma discharge is essentially a function of the product p·d of the pressure of the gas, p, and the electrode separation, d. The magnitude of this voltage is dependent, in a manner known to the skilled person, on the value of p d of the discharge arrangement, and also on the process gas itself.

For the process of the invention, the product of electrode separation and pressure is situated generally in the range from 0.001 to 300 mm·bar, preferably from 0.05 to 100 mm·bar, more preferably at 0.08 to 10 mm·bar. The discharge may be activated by means of various types of AC voltages or pulsed voltages, which may also be unipolar, from 1 to 10⁶ V. The profile of the voltage may be triangular, rectangular, trapezoidal, pulsed, or composed of sections of individual profiles against time. The profile may also have any other shapes known to the skilled person, e.g. sine, or a combination with the stated profiles. Particularly preferred shapes are rectangle or triangle. AC voltage and injected electromagnetic pulses may be combined in each of these time profile shapes, and are likewise influenced by the reactor load.

The pulse duration in pulsed operation is guided by the composition, the residence time and the pressure of the reactant stream. It is preferably between 10 ns and 1 ms. Preferred voltage amplitudes are 10 Vₚₚ (volts peak to peak) to 100 kVₚₚ (kV peak to peak), preferably 100 Vₚₚ to 10 kVₚₚ, more particularly 50 Vₚₚ to 5 kVₚₚ, in a microsystem. In the case of a duty ratio of 10:1, the frequency of the AC voltage may be set from 10 MHz, and 10 ns pulses, down to low frequencies in the range from 10 to 0.01 Hz. For example, an AC voltage having a frequency of 1.9 kHz and an amplitude of 35 kVₚₚ may be applied to the reactor. The power input in the example case is in the range from 20 W to 80 W, preferably from 30 to 70 W, more preferably about 60 W. The power input is determined as DC power in the intermediate circuit of the generator, by multiplication of the average instantaneous values of current and voltage.

In the process of the invention, the AC voltage frequency f may be within a range from 1 Hz to 100 GHz, preferably from 1 Hz to 100 MHz. The repetition rate g of the electromagnetic pulses superimposed on this base frequency may be selected within a range from 0.1 kHz to 50 MHz, preferably from 50 kHz to 50 MHz. The amplitude of these pulses may be selected from 1 to 15 kVₚₚ (kV peak to peak), preferably from 1 to 10 kVₚₚ, more preferably from 1 to 8 kVₚₚ.

This already increases the time-based yield of dimeric and/or trimeric silane considerably as compared with the prior-art process without injected electromagnetic pulse and a sinusoidal profile of the AC voltage that generates the plasma.

A further increase in the yield can be achieved if, in the process of the invention, at least one further electromagnetic pulse with the same repetition rate and with inverse polarity is superimposed on the electromagnetic pulse injected into the plasma, or both the pulses or the at least two pulses are in a duty ratio of 1 to 1000 relative to one another. Preferably, both pulses are selected with a rectangular shape, in each case with a duty ratio of 10 and a very high edge slope. The greater the edge slope, the higher the yield. The amplitude selected for these pulses may be from 1 to 15 kVₚₚ, preferably from 1 to 10 kVₚₚ.

Generally speaking, the yield rises with the repetition rate. It has been observed, for example, that a saturation effect is found—i.e. no further increase is obtained in the yield—for repetition rates with a multiple of the base frequency, for example 10 times the base frequency. The inventors are of the view, without being tied here to any particular theory, that this saturation effect depends on the gas composition, on the p·d value, and also on the electrical adaptation of the plasma reactor to the electronic ballast.

In the process of the invention, the electromagnetic pulse or pulses can be injected through a pulse ballast with current or voltage impression. If the pulse is current-impressed, a greater edge slope is obtained.

In a further version of the process of the invention, the pulse may be injected in a transiently asynchronous manner rather than a periodically synchronous manner, in a way which is known to the skilled person.

If, subsequent to step ii), at least one or precisely one further gas discharge is carried out, a pulsed non-thermal plasma may also be operated in the resulting or further resulting phase. In the event of the further or any further gas discharge, the parameters of frequency f, repetition rate g, edge slope, and pulsewidth may each be selected from the same range. These parameters may also preferably be the same for every gas discharge.

In a further version of the process of the invention, the reactor may be equipped with tubular dielectric material in order to prevent nonuniform fields in the reaction chamber and hence uncontrolled conversion. The ratio of the reactor tube diameter of 10 to 500 mm to its length of 10 to 1000 mm is preferably used. Particularly preferred reactor diameter/length ratios are 300 mm/700 mm, or 20 mm/120 mm. The simultaneous operation of at least one reactor tube, preferably of 2 to 50 tubes, is also preferred.

With further preference, the reactor with the dielectric material forms one unit with the ballast of low-resistance, low-capacitance and broadband design.

In the process of the invention, within the reactor, it is possible to use tubes which are mounted and held apart by spacers made from inert material. Such spacers are used to balance out manufacturing tolerances of the tubes, and also to minimize their mobility in the reactor.

It may likewise be advantageous to use spacers made of electrically conducting material in the process of the invention. Particularly preferred is the use of conductive silver, which is known to the skilled person.

In a further version of the process of the invention, in process step iii), the ratio of the pressure in step ii) to the pressure in step iii) may be set by means of a hydrogen-permeable membrane. With particular preference, in step ii) the pressure may be set from 50 to 500 mbar_{abs}, and the pressure in process step iii) may be set from 0.5 to 100 mbar_{abs}, more preferably at 5 mbar_{abs}.

With further preference, in process step iii), the ratio of the pressure in step ii) to the pressure in step iii) is set by means of a hydrogen-permeable membrane. This membrane is preferably permeable to hydrogen and substantially impermeable to noble gas and silanes.

If subsequent to step ii) at least one or precisely one further gas discharge is carried out, it is possible to use one membrane, or to use two or more such membranes, in order to remove hydrogen from the resulting or further resulting phase.

In a further version of the process of the invention, it is advantageous in step iii) first to remove the dimeric and/or trimeric silanes of the formula I, which may be present in a mixture with silanes of higher molecular mass. The removal takes place with particular preference by distillation, more preferably by means of rectification and/or by filtration. In the case of filtration, it is especially preferred to use a membrane which is permeable only to hydrogen and is substantially impermeable to noble gas and to silanes.

Subsequently, in the resulting phase, a defined ratio can be set between the hydrogen partial pressure and the partial pressure of the silanes which are gaseous under the conditions selected, more particularly the partial pressure of the monosilane. The pressure may be set such that on the filtrate side it is in the range from 5 mbar_{abs} to 100 bar_{abs}. The pressure may regulated so that the hydrogen continually formed anew from the reaction is taken off. In this context it may be advantageous for the process matrix to have a defined hydrogen content of 5%, for example. The pressure on the substance side may be set preferably from 50 mbar_{abs} to 500 mbar_{abs}.

The partial pressures are set in accordance with the invention by means of a membrane, which is preferably permeable only to hydrogen and is substantially impermeable to silanes and noble gases.

In the process of the invention it may likewise be advantageous if in step iii) in the resulting phase at the same time the dimeric and/or trimeric silanes of the formula I are obtained and a defined ratio is set between the hydrogen partial pressure and the partial pressure of the silanes, which are gaseous under the selected conditions, more particularly the partial pressure of the monosilane.

Reactants used are noble gas and monosilane of high to ultra-high purity, complying preferably in each case with the following impurities profile. The monosilane or the noble gas has in each case an impurities total of 100 ppm by weight to 1 ppt by weight, more particularly down to the detection limit, preferably less than or equal to 50 ppm by weight, more preferably less than or equal to 25 ppm by weight. This impurity comprises impurities of boron, phosphorus and metallic elements which do not correspond to silicon. With particular preference the level of impurity, in each case independently for the monosilane and for the noble gas, is as follows for the elements set out hereinafter:
a. aluminium less than or equal to 15 ppm by weight to 0.0001 ppt by weight, and/or
b. boron less than or equal to 5 to 0.0001 ppt by weight, preferably in the range from 3 ppm by weight to 0.0001 ppt by weight, and/or
c. calcium less than or equal to 2 ppm by weight, preferably from 2 ppm by weight to 0.0001 ppt by weight, and/or
d. iron less than or equal to 5 ppm by weight and 0.0001 ppt by weight, preferably from 0.6 ppm by weight to 0.0001 ppt by weight, and/or
e. nickel less than or equal to 5 ppm by weight and 0.0001 ppt by weight, preferably from 0.5 ppm by weight to 0.0001 ppt by weight, and/or
f. phosphorus less than or equal to 5 ppm by weight to 0.0001 ppt by weight, preferably less than 3 ppm by weight to 0.0001 ppt by weight, and/or
g. titanium less than or equal to 10 ppm by weight, less than or equal to 2 ppm by weight, preferably
   less than or equal to 1 ppm by weight to 0.0001 ppt by weight, further preferably from 0.6 ppm by weight to 0.0001 ppt by weight, especially preferably from 0.1 ppm by weight to 0.0001 ppt by weight, and/or
h. zinc less than or equal to 3 ppm by weight, preferably less than or equal to 1 ppm by weight to 0.0001 ppt by weight, especially preferably from 0.3 ppm by weight to 0.0001 ppt by weight,
i. carbon and, if present, halogens together in a concentration which adds up to the sum total of the concentrations a. to h. The value obtained in this way is from 100 ppm by weight to 1 ppt by weight.

The concentration of each impurity a. to h. is preferably in the region of the detection limit, which is known to the skilled person.

Impurities such as water, for example, may be converted easily in the silane plasma to SiOₓ with x=1 and/or 2, and to hydrogen. SiOₓ deposits as a powder. Furthermore, the plasma reaction of the invention brings about purification of the noble gas used, since this gas, in the plasma, is freed from or at least depleted in impurities in the form of hydrocarbons, water and oxygen. The purification is particularly effective if in accordance with the invention at least one further gas discharge is carried out.

The process is also particularly advantageous if, when it is carried out, the reactant stream in step ii) is subjected to a gas discharge at a pressure of 5 mbar_{abs} to 100 bar_{abs}, very preferably of 7.5 mbar_{abs} to 100 mbar_{abs}, more preferably of 10 mbar_{abs} to 80 mbar_{abs}, preferably in a non-thermal plasma at a temperature of −160° C. to 10° C., more particularly of −40 to 0° C., with further preference around −10° C. plus/minus 5° C.

It is also preferred if in process step ii) the gas discharge takes place at a pressure of 0.1 mbar_{abs} to 1000 mbar_{abs}, preferably of 0.1 to 800 mbar_{abs}, more preferably of 1 mbar_{abs} to 500 mbar_{abs}. With further preference the pressure range is from 10 to 100 mbar_{abs}, preferably from 10 to 80 mbar_{abs}. It is further preferred here if the gas discharge, more particularly the non-thermal plasma, is operated in step ii) at a temperature of −160° C. to 100° C., preferably from −100° C. to 10° C. If the preferred pressure and temperature ranges are maintained during the plasma treatment of the reactant stream, it is possible to excite the Si—H bond selectively to an extent such that there is formation of silyl radicals and, subsequently, dimerization of silyl radicals. For selective silyl radical formation by excitation and cleavage of the Si—H bond, a mean electron energy of 5 eV in the weakly ionizing non-thermal plasma is required. The inventors suppose that in the event of further chain build-up, there is insertion of SiH₂ radicals into Si—H or Si—Si bonds of disilanes. In the event of too high an energy input in the region of 12.3 eV, rather than selective radical formation, unwanted SiH₃⁺ ions would be formed, which lead to deposition of silicon on further breakdown. For high yields of disilane and trisilane, it is therefore crucial to optimize the process conditions in the non-thermal plasma for selective radical formation and the possibilities of recombination to higher silanes, and at the same time to suppress the formation of further decomposition products. The disilane and/or trisilane formed here may subsequently be condensed out via a suitable setting of temperature and of pressure, preferably in the steps iv.a) and iv.b) outlined below, using a condenser, by using a compressor to set the pressure at a pressure of 0.1 bar_{abs} to 500 bar_{abs}, preferably of 1 bar_{abs} to 100 bar_{abs}, more preferably of 1 to 10 bar_{abs}, with a temperature of −160° C. to 20° C.

For complete removal it may be advantageous, in a further process step iv.a),
iv.a) to set a temperature in the aforementioned condenser in the range from −120 to 10° C. at a pressure of between 0.1 to 10 bar_{abs}, preferably of 1 to 5 bar_{abs},
   and in a subsequent step iv.b),
iv.b) in the crude product container or crude product drain, preferably at the same pressure and at −60 to −20° C.,
   to remove the disilane and/or trisilane from the resulting phase by condensation. The pressure can be set in a conventional way, as known to the skilled person.

The resulting phase or further resulting phase is preferably contacted with a hydrogen-permeable membrane, and here a defined ratio of the hydrogen partial pressure to the partial pressure of the silanes, which are gaseous under the selected conditions, more particularly the partial pressure of the unreacted monosilane, may come about.

The resulting phase or further resulting phase thus treated, following the partial removal of hydrogen, is fed to the reactant stream again, to which further monosilane may be added, before it is fed to the non-thermal plasma.

In this way, unconverted reactant of the general formula II can, if required, be fed again to the non-thermal plasma. For full conversion of the monosilane used to disilane and/or trisilane of the general formula I, the process is preferably operated as a cycle operation, by running through process steps i), ii) and iii). The disilane and/or trisilane of the general formula I obtained by means of the reaction in the non-thermal plasma may already be obtained in pure form in the process.

After the process of the invention has been carried out, disilane and/or trisilane are obtained in ultra-high purity and in isolation from the other reaction products and reactants. In a ²⁹Si NMR spectrum, measured in a way which is routine in the art, aside from the signal for the silane of the formula I, no further compounds are detectable. The contamination by other metal compounds is therefore within a range from 1000 ppb by weight to 100 ppt by weight, or below. A particular advantage of the higher silanes prepared by the process of the invention is that they are free from residues of catalysts which are otherwise commonly used. Furthermore, the stated noble gases permit a gentler or more uniform discharge in the reactor, synonymous with a less filamented discharge.

With particular preference, the silane I obtained in accordance with the invention is of ultra-high purity and has in each case, in sum total, a total contamination of less than or equal to 100 ppm by weight down to the detection limit, more particularly down to 1 ppt by weight; the total contamination is preferably less than or equal to 50 ppm by weight. Total contamination is understood as being contamination by boron, phosphorus and metallic elements which do not correspond to silicon. More preferably, the total contamination of the disilane and/or trisilane for the following elements is less than or equal to:
a. aluminium less than or equal to 15 ppm by weight to 0.0001 ppt by weight, and/or
b. boron less than or equal to 5 to 0.0001 ppt by weight, preferably in the range from 3 ppm by weight to 0.0001 ppt by weight, and/or
c. calcium less than or equal to 2 ppm by weight, preferably between 2 ppm by weight and 0.0001 ppt by weight, and/or
d. iron less than or equal to 5 ppm by weight and 0.0001 ppt by weight, especially between 0.6 ppm by weight and 0.0001 ppt by weight, and/or
e. nickel less than or equal to 5 ppm by weight and 0.0001 ppt by weight, especially between 0.5 ppm by weight and 0.0001 ppt by weight, and/or
f. phosphorus less than or equal to 5 ppm by weight to 0.0001 ppt by weight, especially less than 3 ppm by weight to 0.0001 ppt by weight, and/or
g. titanium less than or equal to 10 ppm by weight, less than or equal to 2 ppm by weight, preferably less than or equal to 1 ppm by weight to 0.0001 ppt by weight, especially between 0.6 ppm by weight and 0.0001 ppt by weight, preferably between 0.1 ppm by weight and 0.0001 ppt by weight, and/or
h. zinc less than or equal to 3 ppm by weight, preferably less than or equal to 1 ppm by weight to 0.0001 ppt by weight, especially between 0.3 ppm by weight and 0.0001 ppt by weight,
i. carbon and halogens together in a concentration which adds up to the sum of concentrations a. to h. The value thus obtained is less than or equal to 100 ppm by weight.

The concentration of each impurity a. to i. is preferably in the region of the detection limit as known to the skilled person. The total contamination with the aforementioned elements is preferably determined by means of ICP-MS. Overall, the procedure can be monitored continuously by means of online analysis. The required purity can be checked by means of GC, IR, NMR, ICP-MS, or by resistance measurement or GC-MS after deposition of the Si.

Additionally or alternatively to one of the aforementioned features, it is preferable if in process step iii), the resulting phase is set to a pressure of 0.05 bar_{abs} to 100 bar_{abs}, for example to 0.1 to 100 bar_{abs}, more particularly to a pressure of 1 bar_{abs} to 100 bar_{abs}, the pressure more preferably being from 0.5 or 1 bar_{abs} to 60 bar_{abs}. Particularly preferred is a pressure to 1 to 10 bar_{abs}.

As a hydrogen-permeable membrane, for all stated embodiments of the process, preference is given to using a membrane which comprises the following materials: quartz, suitable metal, suitable metallic alloy, ceramic, zeolite, organic polymer and/or a composite membrane comprising an at least two-layer structure with one or more of the aforementioned materials. In order to be a suitable material for the hydrogen-permeable membrane, the material, for example, quartz or palladium, has to have pores with a defined size, through which hydrogen can diffuse but monosilane cannot. A membrane which can be used with preference may comprise, for example, a ceramic membrane having a layer structure having a first microporous layer with pores smaller than 2 nm, adjoined by a mesoporous layer having pores between 3 and 10 nm, with optional provision of another, macroporous layer having large pores up to 100 nm. It is preferable when the macroporous layer is a porous ceramic material or a sintered metal. If the membrane has a continuous palladium layer, hydrogen is able to diffuse through the interstitial lattice sites of the palladium.

Suitable membranes may preferably include the following materials: palladium, a palladium alloy, such as PdAI, PdCu, quartz and/or an organic synthetic polymer, such as, preferably, hollow fibre membranes, where the membranes must be permeable to hydrogen. Preferred hollow fibre membranes may be produced from polyamides, polyimides, polyamide-imides or else from mixtures thereof. Where a palladium membrane is selected, it may be produced, for example, by chemical vapour deposition, electrochemical deposition, high-velocity flame spraying or physical vapour deposition, or by electron beam vaporization.

Because of the high purity demands in relation to contamination with metallic elements, preference is given to utilizing an ultrahigh-purity quartz membrane in the process and/or in the plant. This membrane should have a pressure stability greater than 1 bar_{abs}, preferably greater than 2 bar_{abs}, more preferably greater than 3 bar_{abs}, and may preferably be applied on a porous Si support or aluminium oxide support. The same applies to palladium-based membranes, which may be produced from a Palladium-aluminium alloy or palladium-copper alloy, and may preferably have a pressure stability of greater than 3 bar_{abs}, on a porous Si support or aluminium oxide support.

Likewise a subject of the invention is a plant (0), more particularly for implementing the aforementioned process, which has a reactor (1) for generating a gas discharge, connected on the outlet side with a rectification column (2), and having a hydrogen-permeable membrane (3) at the top of the rectification column (2), in order to set a defined ratio of the hydrogen partial pressure to the partial pressure of the gaseous silanes in the resulting phase. An advantage of this plant is that ahead of the membrane (2) there is no need for a compressor in order to increase the pressure of the resultant phase.

It may be advantageous to provide a pump on the permeate side of the membrane (2), in order to carry off the hydrogen and so to increase the filtration performance.

Further to the stated reactor (1), the plant may also have one or more additional reactors, connected in series or in parallel. At least one of these reactors may be an ozonizer, which is operated in dependence on the pressure with a large discharge gap, and in which a non-thermal plasma is generated. A great advantage lies in the alternative possibility of using commercial ozonizers, thereby significantly lowering the capital costs. The reactors of the invention are equipped usefully with glass tubes, more particularly with quartz-glass tubes, the tubes being arranged preferably parallel or coaxially and being spaced apart by means of spacers made from inert material. Especially suitable inert material includes Teflon, glass, and also, generally, low-κ materials, which have a low dielectric constant. Materials having a low dielectric constant are considered to be those whose dielectric constant is less than or equal to 9. Alternatively, instead of with glass tubes, the reactors may also be furnished with tubular dielectric components.

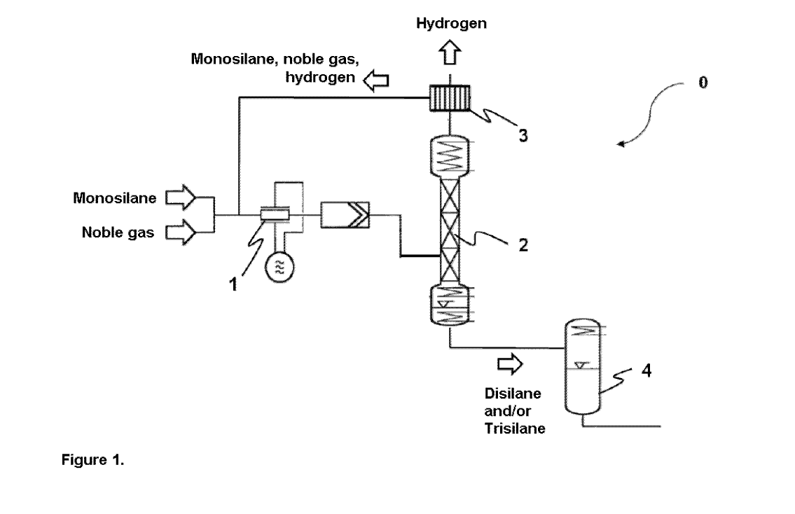

In the rectification column (2) of the plant (0), shown in FIG. 1, accumulation of the product mixture in the liquid phase is implemented. Withdrawn from the liquid phase in this column are ultra-high-purity dimeric and/or trimeric silanes. The plant of the invention may preferably have a product container (4), from which the dimeric and/or trimeric silanes can be withdrawn.

In a further embodiment, the member (2) may be connected to a condenser. This condenser may further be connected, preferably on the outlet side, to a crude product drain or crude product container.

The examples which follow illustrate the process of the invention.

### COMPARATIVE EXAMPLE 1

In a reactant stream of 22 g/min, obtained from a mixture comprising 13.8 kg of Monosilan EG, available from Evonik Industries AG, and 0.58 kg of hydrogen, a plasma having an AC voltage frequency of 1.8 kHz was generated. The power input was an average of 60 W—measured in the DC intermediate circuit of the plasma generator—and the ratio of the reactor tube diameter to its length was 20 mm/120 mm.

Under a pressure of 40 mbar_{abs}, the reactant stream was drawn over a filter, in order to remove Si particles formed during the conversion in the plasma, and was thereafter pressurized with a compressor.

Approximately 10% of the monosilane originating from the mixture was converted into disilane, Si particles and other fractions. From the monosilane not converted in the plasma, it was possible, under a pressure of 1 bar_{abs} and at a condensation temperature of minus 120° C., to recover only about 7%, together with disilane and other fractions.

### COMPARATIVE EXAMPLE 2

A reactant stream of 260 g/min disilane was heated under a pressure of 2.1 bar_{abs} to a temperature of 350° C., by means of a two-stage heating system, and was introduced into a tubular reactor vessel, in which the temperature was maintained at 350° C. The reactor vessel had a length/diameter ratio of 5:1.

The product stream at the gas outlet contained about 2.17 wt % of trisilane. As by-products, hydrogen and 4.1 wt % of monosilane were taken off at the top.

### INVENTIVE EXAMPLE 1

This example was carried out in the same way as for Comparative Example 1, but differs in that the hydrogen in the reactant stream was replaced on a molar-fraction basis by xenon.

Under a pressure of 40 mbar_{abs}, the reactant stream was drawn over a filter, in order to remove Si particles formed during the conversion in the plasma, and was thereafter pressurized with a compressor.

At a pressure of 1 bar_{abs} and a condensation temperature of minus 120° C., about 85% of the monosilane employed was recovered, together with disilane, xenon and other fractions. Apart from monosilane and discharged hydrogen, the fraction recovered contained about 7% of disilane, 3% of Si particles and 1% of other fractions.

### INVENTIVE EXAMPLE 2

This example was performed like the comparative example, but differs in that the hydrogen in the reactant stream was replaced on a molar-fraction basis by xenon, and the reactant stream was drawn over a filter at a reactor pressure of 240 mbar_{abs}, in order to remove Si particles formed during the reaction in the plasma, and was thereafter pressurized with a compressor.

At a pressure of 1 bar_{abs} and a condensation temperature of minus 120° C., about 85% of the monosilane employed was recovered, together with disilane, xenon and other fractions. Apart from monosilane and discharged hydrogen, the fraction recovered contained about 16% of disilane, 3% of Si particles and 3% of other fractions.

The general procedure for the examples is not restricted to the specific process parameters identified, but may instead be generalized in accordance with the description.

### LIST OF REFERENCE NUMERALS

0 Plant
1 Reactor for generating a gas discharge
2 Membrane
3 Rectification column
4 Product container

1. A process for preparing a dimeric silane and/or a trimeric silane, the process comprising: 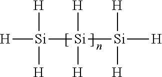
i) providing a reactant stream comprising a monosilane of a general formula II 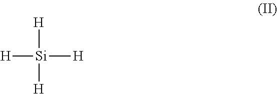
and a noble gas,
ii) operating a gas discharge to give a resulting phase which comprises hydrogen, the noble gas, and the dimeric silane and/or the trimeric silane, and subsequently
iii) removing the noble gas, hydrogen, and the dimeric silane and/or the trimeric silane from the resulting phase, wherein the dimeric silane and/or the trimeric silane is of a general formula I 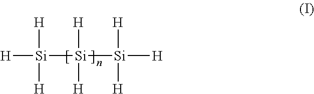
where n=0, n=1, or n ranges from 0 to 1.

2. The process according to claim 1, wherein xenon or krypton is used as the noble gas in step i).

3. The process according to claim 1, wherein before step iii) and after step ii), a further gas discharge is carried out in the resulting phase at least once, to give a further resulting phase, in which a fraction of the trimeric silane is greater than a fraction of the dimeric silane.

4. The process according to claim 1, wherein in process step ii) the gas discharge is carried out in a loop reactor and a pressure is set from 50 to 200 mbar, and/or a pressure in process step iii) is set from 0.5 to 100 mbar.

5. The process according to claim 1, wherein in process step ii) the gas discharge takes place at a temperature ranging from −160° C. and 200° C.

6. The process according to claim 1, wherein the reactant stream has a ratio of the noble gas to the monosilane in volume percent (vol %) in a range of 20:1 to 1:5.

7. The process according to claim 1, wherein the reactant stream in step ii) is exposed to a pulsed non-thermal plasma, where a non-thermal plasma is activated by an AC voltage of frequency f, and at least one electromagnetic pulse with repetition rate g injected into the non-thermal plasma has a voltage component having an edge slope in a rising edge of 10 V ns⁻¹ to 1 kV ns⁻¹, and has a pulse width b in a range of 500 ns to 100 μs.

8. The process according to claim 1, wherein in process step iii) a ratio of the pressure in step ii) to the pressure in step iii) is set by a hydrogen-permeable membrane.

9. The process according to claim 8, wherein the membrane is permeable to hydrogen and is substantially impermeable to the noble gas and silanes.

10. The process according to claim 8,
wherein the membrane comprises:
at least one material selected from the group consisting of quartz, metal, metallic alloy, ceramic, zeolite, and organic polymer, and/or
a composite membrane comprising at least a two-layer construction comprising one or more of the aforementioned materials.

11. A plant for performing the process according to claim 1, comprising:
a reactor for generating a gas discharge, connected on an outlet side to a rectification column, and
a hydrogen-permeable membrane at the top of the rectification column, in order to set a defined ratio of a hydrogen partial pressure to a partial pressure of gaseous silanes in the resulting phase.

12. The plant according to claim 11, wherein the membrane is connected to a condenser which is connected on the outlet side to a crude product drain or a crude product container.

13. The process according to claim 3, wherein the further gas discharge is carried out once.

14. The process according to claim 4, wherein the pressure in process step iii) is set to 5 mbar.

15. A process for preparing a dimeric silane and/or a trimeric silane, the process comprising:
i) providing a reactant stream comprising a monosilane of a general formula II 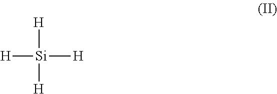
and a noble gas,
ii) operating a gas discharge to give a resulting phase which comprises hydrogen, the noble gas, and the dimeric silane and/or the trimeric silane, and subsequently
iii) removing the noble gas, hydrogen, and the dimeric silane and/or the trimeric silane from the resulting phase, wherein the dimeric silane and/or the trimeric silane is of a general formula I 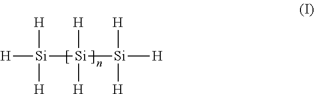
where n=0, n=1, or n ranges from 0 to 1, and comprises less than 100 ppt of a metal by weight.

16. A process for preparing a dimeric silane and/or a trimeric silane, the process comprising:
i) providing a reactant stream comprising a monosilane of a general formula IT 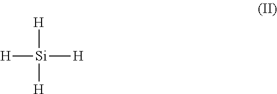
and a noble gas,
ii) operating a gas discharge to give a resulting phase which comprises hydrogen, the noble gas, and the dimeric silane and/or the trimeric silane, and subsequently
iii) removing the noble gas, hydrogen, and the dimeric silane and/or the trimeric silane from the resulting phase, wherein the dimeric silane and/or the trimeric silane is of a general formula 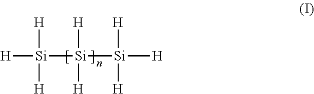
where n=0, n=1, or n ranges from 0 to 1, and comprises 100 ppt to 1000 ppb of a metal by weight.
